(19) United States
(12) Patent Application Publication
(10) Pub. No.: US 2011/0079471 A1
(43) Pub. Date: Apr. 7, 2011

(54) ELECTRIC BRAKING CIRCUIT PROVIDED WITH MEANS FOR CONTROLLING MEMBERS FOR BLOCKING THE PUSHERS OF ELECTROMECHANICAL ACTUATORS FITTED TO AN AIRCRAFT BRAKE

(75) Inventors: Emmanuel Colin, Paris (FR); Julien Thibault, Gyf-Sur-Yvette (FR); Stephane Mudry, Issy Les Moulineaux (FR)

(73) Assignee: MESSIER-BUGATI, Velizy- Villacoublay (FR)

(21) Appl. No.: 12/996,280

(22) PCT Filed: Jun. 3, 2009
(86) PCT No.: PCT/FR09/00642

§ 371 Date: Dec. 3, 2010

(30) Foreign Application Priority Data
Jun. 4, 2008 (FR) 0803092

(51) Int. Cl. B64C 25/44; G06F 19/00; B60T 8/17; B64C 25/42

(52) U.S. Cl. 188/106 P; 701/3

(57) ABSTRACT

The invention relates to an aircraft braking circuit having brakes with electromechanical actuators for braking wheels located at the bottom end of at least one undercarriage. In accordance with the invention, a remote unit is located at the bottom of the undercarriage close to the actuators and connected to a certain number of said actuators, the remote unit receiving a power supply via a power supply cable going down along the undercarriage, and having as many controlled switches as connected actuators for selectively powering blocking members fitted to the connected actuators, the switches being controlled independently of one another by software parking orders generated by a control unit and passing via a single communications bus going down along the undercarriage to the remote unit.

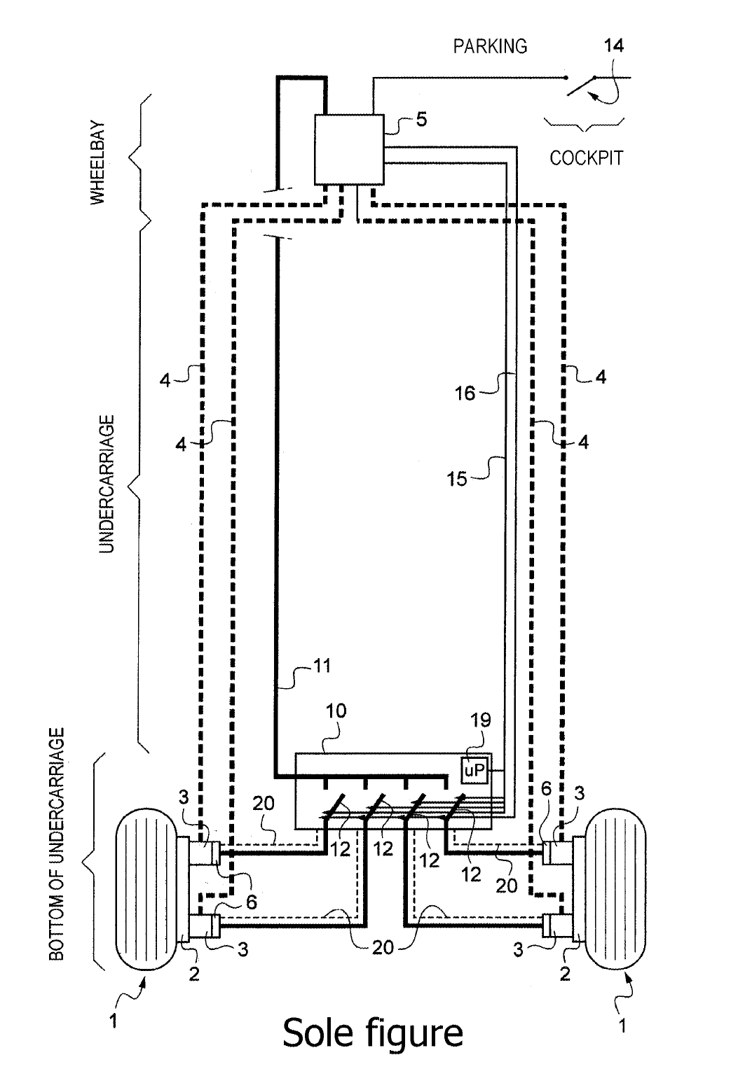

The invention relates to an electrical braking circuit provided with means for controlling the blocking members of pushers of electromechanical actuators fitted to an aircraft brake.

### BACKGROUND OF THE INVENTION

In aircraft provided with brakes having electromechanical actuators, it is known to perform the parking brake function (i.e. preventing the aircraft from moving without it being necessary for the pilot to press continuously on the brake pedals) by executing the following sequence:
powering the actuators so that each of them delivers a parking braking force;
blocking the actuators in position; and
switching off the power supply to the actuators.

For this purpose, each actuator is provided with a blocking member that enables the pusher of the actuator to be held in position in selective manner. In practice, the blocking member is constituted for example by a fail-safe brake that is normally powered to allow the pusher of the actuator to move freely under drive from the electric motor of the actuator, but that has its power supply interrupted in order to block the pusher in position when switching to parking mode. That type of blocking member needs no more than a low-voltage power supply (typically at 28 volts (V)) and is therefore capable of being controlled by means of a two-state signal that acts simultaneously as a control signal and as a power supply.

Two schemes for controlling the blocking member can be envisaged. In a first scheme, a parking brake signal for the actuators is sent independently to each of them. That solution provides a high degree of controllability over the actuators, since it is possible to control each blocking member independently of the others. Nevertheless, that solution requires as many cables to extend down along the undercarriage as there are actuators to be controlled, thereby increasing the weight of the assembly. In another scheme, only one parking brake signal is sent simultaneously to all of the actuators controlled by the unit, using a single power supply cable going down along the undercarriage. Although that scheme is lighter in weight than the preceding scheme, it does not enable the actuators to be controlled independently and thus reduces the controllability thereof.

### OBJECT OF THE INVENTION

The invention seeks to provide a novel braking circuit offering a compromise between weight and controllability that is advantageous for controlling the members for blocking the pushers of the actuators of a brake, in particular in order to provide a parking brake function.

### BRIEF SUMMARY OF THE INVENTION

According to the invention, there is provided an aircraft braking circuit having brakes with electromechanical actuators for braking wheels located at the bottom end of at least one undercarriage, the braking circuit including a remote unit located at the bottom of the undercarriage close to the actuators and connected to a certain number of said actuators, the remote unit receiving a power supply via a power supply cable going down along the undercarriage, and having as many controlled switches as connected actuators for selectively powering blocking members fitted to the connected actuators, the switches being controlled independently of one another by software parking orders generated by a control unit and passing via a single communications bus going down along the undercarriage to the remote unit.

Thus, although independent control is provided for each of the actuator blocking members, controlling these blocking members requires only one power supply cable and a communications bus, and this continues to be true regardless of the number of actuators concerned. This retains independent control over each of the blocking members while minimizing the number of cables that are needed to control these blocking members, and thus minimizing the weight of the braking circuit.

In a preferred embodiment, the unit receives a hardware order coming from a selector operated by the aircraft crew and delivered via a channel that is physically separate from the communications bus. Preferably, the software orders have priority over the hardware order. The hardware order thus controls the actuator blocking members only if the controller that generates the software orders is switched off or has failed.

Preferably, the remote unit also includes means for concentrating data coming from sensors associated with the brakes or with the braked wheels in order to collect, format, and relay said data to the aircraft via the communications bus.

### BRIEF DESCRIPTION OF THE DRAWING

The invention can be better understood in the light of the description of the sole FIGURE showing diagrammatically a braking circuit in a particular embodiment of the invention.

### DETAILED DESCRIPTION OF THE INVENTION

The FIGURE shows the braking circuit of the invention as implemented on an undercarriage having two braked wheels 1 with brakes 2 each having two electromechanical braking actuators 3. Each actuator includes a pusher (not shown) that can be moved in register with friction disks placed in the associated wheel, movement being driven by an associated electric motor so as to exert braking torque on the wheel.

Naturally, the wheels are carried at the bottom of an undercarriage to enable the aircraft to make contact with and travel on the ground. The electromechanical actuators 3 are powered by power cables 4 represented by bold dashed lines, that go down along the undercarriage towards each of the braking actuators 3 and that come from a control unit 5 (also referred to as an electromechanical actuator controller (EMAC)) located in a wheel bay of the aircraft for receiving the undercarriage when it is raised. The control unit 5 receives high power (typically at 270 V) from the power circuit of the aircraft and it delivers the high power it receives selectively to the electric motors of the actuators 3 by means of the power cables 4 as a function of braking orders received from a braking computer (not shown).

All of the electromechanical actuators 3 are fitted with respective blocking members 6, here constituted by fail-safe brakes, that on being powered leave the pusher of the associated actuator free to move under drive from the associated electric motor, but when no longer powered, block the pusher in position. Here the fail-safe brakes 6 are powered at low power (typically 28 V).

According to the invention, the braking circuit includes a remote unit 10 located in the bottom portion of the undercarriage, close to the wheels 1. The remote unit 10 is powered at low power by means of a low power cable 11 represented by a bold continuous line running down along the undercarriage. The remote unit includes as many controlled switches 12 as there are blocking members to be controlled, thereby enabling low power to be delivered selectively to each of the blocking members 6, independently of the others.

To control the switches, the unit remote 10 receives two types of order:
software orders, one per switch, which orders are generated by the control unit 5 in response to orders coming either from the pilot or from a braking computer, and are transmitted to the remote unit 10 by means of a communications bus 15 going down along the undercarriage. By way of example, these software orders may be generated by the braking computer when the aircraft has been stationary for a certain length of time and the pilot continues to press on the brake pedals. The braking computer then causes all of the brakes to switch to a parking mode, without informing the pilot, thereby enabling the power supply to be motors of the actuators to be switched off and thus avoiding pointless heating, while nevertheless keeping the aircraft stationary. In the FIGURE, the four braking software orders coming from the communications bus 15 are represented diagrammatically as controlling respective ones of the switches 12; and
a single hardware order for all of the controlled switches 12 coming from a parking selector 17 located in the cockpit and actuated by the pilot. The hardware order is thus generated independently of the control unit 5. Here, the control unit 5 does no more than relay the hardware order to the remote unit 10 merely by means of a transmission cable 16 that goes down along the undercarriage.

The remote unit 10 operates as follows: each controlled switch is normally closed, thereby enabling the fail-safe brakes that constitute the blocking member 6 to be powered and thus allowing the movement of each of the actuator pushers to be moved freely under the drive of the associated motor. In the event of a software order occurring, the corresponding switch 12 is opened, thereby switching off the power supply to the corresponding fail-safe brakes, and thus preventing the associated pusher from moving. In normal operation, and in particular when the aircraft is under electrical power and the control unit 5 is operating normally, the hardware order has no direct effect on the switches. Thus, the software orders have priority over the hardware order, even though it is the pilot who operates the parking selector 17. It is only in the event of the control unit 15 failing, or in the event of it no longer being powered for any reason whatsoever, that the arrival of a hardware order causes all of the control switches to be opened, thereby preventing all of the associated pushers from moving.

Thus, even if there is a problem in the generation of software orders, the pilot always retains the possibility of forcing the braking circuit to cause all of the pushers of the actuators to be prevented from moving.

The braking circuit of the invention thus provides the parking function, while requiring only a remote unit 10, a communications bus 15, and a transmission cable 16, regardless of the number of brakes and actuators to be managed at the bottom of the undercarriage. The braking circuit of the invention thus enables the actuators to be controlled independently, while limiting the number of cables going down along the undercarriage.

It is extremely advantageous to take advantage of the presence of the remote unit 10 and use it to perform other functions. For example, the remote unit 10 may serve as a local data concentrator. Data such as the speeds of rotation of the wheels and the angular positions of the motors may be taken to the remote unit 10 by wire connections 20 represented by fine dashed lines, with the remote unit 10 being fitted with processor means (e.g. a microcontroller 19) for receiving, formatting, and finally relaying said data to the control unit 5 via the communications bus 15. These processor means are powered by the low-power cable 11 that extends to the remote unit 10.

Thus, the mechanical structure of the unit, the low-power supply, and the communications bus are used in common to enable the same equipment to perform the function of controlling the blocking members and the function of concentrating data. The braking circuit of the invention thus provides significant savings of means in order to perform a plurality of functions.

The invention is not limited to the above description, but on the contrary covers any variant coming within the ambit defined by the claims.

In particular, the low-power power supply 11 for the remote unit 10, here taken directly from the low-power circuit of the airplane, could in a variant pass via the control unit 5. Furthermore, the remote unit 10 may be fitted with a local power supply, e.g. of the capacitive type, which is charged in operation from the low-power power supply, but is capable of delivering power as a replacement for the low-power power supply should it fail or should the power-supply cable be cut. It then suffices for the capacitive source to be capable of delivering power for a sufficient period of time, in practice a short period, to block the pushers of the actuators when that is required, or to extend unblocking, where appropriate. In a variant, the local power supply may be installed in the control unit 5.

In addition, for a given undercarriage, it is possible to provide a plurality of remote units. For example, for an undercarriage including a rocker beam carrying four wheels, one remote unit may be provided for the front wheels and another remote unit for the rear wheels. For safety reasons, the communications bus and the cable for transmitting the hardware order may also be fitted redundantly for each of the units.

Although in the example shown it is stated that the control unit 5 does no more than relay the hardware parking order, it may also serve to acquire it, in order to provide redundancy, or indeed to generate software orders for controlling the blocking members.

Finally, although it is explained how the invention serves to control the blocking members of the actuator pushers, and how this control enables the parking brake to be operated, the invention is naturally not limited to this application. The blocking members may be controlled in circumstances other than providing a parking brake, for example when testing operation, or indeed for blocking the pushers for safety reasons while the undercarriage is raised in the wheelbay.

1. An aircraft braking circuit having brakes with electromechanical actuators for braking wheels located at the bottom end of at least one undercarriage, wherein the circuit includes a remote unit located at the bottom of the undercarriage close to the actuators and connected to a certain number of said actuators, the remote unit receiving a power supply via a power supply cable going down along the undercarriage, and having as many controlled switches as connected actuators for selectively powering blocking members fitted to the connected actuators, the switches being controlled independently of one another by software parking orders generated by a control unit and passing via a single communications bus going down along the undercarriage to the remote unit.

2. An aircraft braking circuit according to claim 1, wherein a transmission cable independent from the communications bus goes down along the undercarriage to transmit a hardware parking order to the remote unit, which order is generated by a parking selector operated by the pilot of the aircraft, independently of the control unit.

3. A braking circuit according to claim 1, wherein the remote unit also includes data processor means for processing data coming from sensors associated with the brakes or the braked wheels in order to collect, format, and relay said data to the aircraft via the communications bus.

4. A braking circuit according to claim 1, wherein the remote unit is powered directly by the power supply network of the aircraft.

5. A braking circuit according to claim 1, wherein the remote unit is powered via the control unit.

6. A braking circuit according to claim 1, wherein the remote unit or the control unit include a local power supply.
